(19) United States
(12) Patent Application Publication
(10) Pub. No.: US 2021/0067624 A1
(43) Pub. Date: Mar. 4, 2021

(54) ONBOARD CALLING DEVICE

(71) Applicant: BORQS BEIJING LTD., Beijing (CN)

(72) Inventor: Xuebin LIANG, Beijing (CN)

(21) Appl. No.: 16/962,217

(22) PCT Filed: Mar. 23, 2018
(86) PCT No.: PCT/CN2018/080115

§ 371 Date: Jul. 14, 2020

(30) Foreign Application Priority Data
Jan. 16, 2018 (CN) 201820069115.X

(51) Int. Cl. H04M 1/725

(52) U.S. Cl. CPC H04M 1/72569; H04M 1/7253; H04M 1/72597

(57) ABSTRACT

An onboard calling device has a processor, a speed measuring module, a weather module, a wireless connection module, and a calling module. The speed measuring module obtains current vehicle speed information. The weather module obtains current weather information. The processor is respectively connected to the speed measuring module and the weather module and determines, according to vehicle speed information and weather information, whether to accept or decline an incoming call, or to hang up a call and send an SMS message. The wireless connection module is used to perform information transmission between the processor and an external communication device. The onboard calling device determines, according to vehicle speed information or weather information, whether to accept or decline an incoming call, or to hang up a call and send an SMS message, thereby achieving automatic operation of an onboard phone function.

### TECHNICAL FIELD

The utility model relates to the technical field of communication, in particular to an onboard calling device.

### BACKGROUND ART

With the improvement of living standard of people, automobiles are widely used as a means of transportation, but tragedies often occur because the driver talks on the telephone while driving. Existing onboard Bluetooth phones in cars are designed for driving safety and comfort. The driver can have a calling with the external world without cable or telephone bracket. However, the traffic condition in the driving process varies rapidly, and traffic accidents often happen instantaneously. Even though a cable or telephone bracket is not required for making a call, the attention of the driver may be severely distracted or the emotion of the driver may be affected severely if the driver talks on the telephone while driving, doing two things at one time. Especially, during driving at a high speed or in bad weather, it is difficult to find or handle dangerous situations, and it is very easy to have a traffic accident.

### CONTENTS OF THE INVENTION

To overcome the drawbacks in the prior art, the purpose of the present utility model is to provide an onboard calling device, which automatically answers an incoming call or hangs up a calling by monitoring vehicle speed and external weather.

To attain the above-mentioned object, the onboard calling device provided by the present utility model comprises a processor, a speed measuring module, a weather module, a wireless connection module, and a calling module, wherein,

the speed measuring module obtains the current vehicle speed information; the weather module obtains the current weather information;

the processor is connected with the speed measuring module and the weather module respectively, and determines whether to accept or decline an incoming call or hang up a calling, and send a short message, according to the vehicle speed information or the weather information;

the wireless connection module is connected with the processor, and is used to perform information transmission between the processor and an external communication device.

Furthermore, the onboard calling device further comprises a storage module for storing the vehicle speed information, the weather information, and the short message.

Furthermore, the wireless connection module is a Bluetooth module or a WiFi module.

Furthermore, the speed measuring module obtains the current vehicle speed via an existing onboard system.

Furthermore, the weather module obtains the current weather information from a server via the existing onboard system.

The onboard calling device provided by the present utility model employs a speed measuring module and a weather module to detect the vehicle speed and the external weather, and can hang up the current calling or automatically answer the current incoming call when the vehicle speed is too high or the external weather is too bad, so as to prevent any traffic accident resulted from any dangerous situation that is not discovered or handled timely due to the calling, when the driver is driving at a high speed or the weather is very bad.

Hereunder other characteristics and advantages of the present utility model will be described, and can become partially apparent from the description or be understood by embodiments of the present utility model.

### DESCRIPTION OF DRAWINGS

The drawings are used to provide a further understanding of the present utility model, and constitute a part of the description. The drawings are used to explain the present utility model in conjunction with the embodiments of the utility model, but do not constitute any limitation to the present utility model. In the drawings:

FIG. 1 is a schematic structural view of the onboard calling device according to the present utility model.

In the figure: 11—processor; 22—speed measuring module; 23—weather module; 24—wireless connection module; 25—calling module; 17—storage module; 18—external communication device.

### Embodiments

Hereunder the preferred embodiments of the utility model will be described with reference to the drawings. It should be understood that the preferred embodiments described herein are only used to describe and explain the utility model, and are not used to limit the utility model.

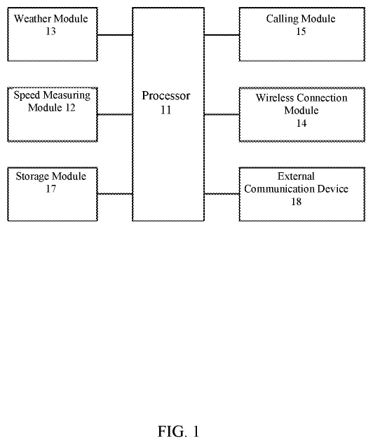

FIG. 1 is a schematic structural view of the onboard calling device according to the present utility model. As shown in FIG. 1, the onboard calling device provided by the present utility model comprises a processor 11, a speed measuring module 12, a weather module 13, a wireless connection module 14, a calling module 15, and a storage module 17, wherein,

the speed measuring module 12 obtains the current vehicle speed via an existing onboard system;

the weather module 13 obtains the current weather information from a server via the existing onboard system;

the output end of the speed measuring module 12 and the output end of the weather module 13 are connected to the input end of the processor 11 to transmit the current vehicle speed information and weather information to the processor 11.

The calling module 15 is connected to the output end of the processor 11, and the calling module 15 comprises a microphone and a speaker for the driver to make a calling.

The wireless connection module 14 is connected to the processor 11 and connected with an external communication device 18. The external communication device 18 can be connected with the processor 11 via the wireless connection module 14, and the calling module 15 is also connected with the external communication device 18 via the wireless connection module 14 so as to realize a calling function.

The wireless connection module 14 may be a Bluetooth module or a WiFi module, or the like.

The storage module 17 is configured to store the vehicle speed information, the weather information, and the short message, etc.

The processor 11 of the present utility model can reject an incoming call and reply with a short message according to the current vehicle speed and the current weather condition.

The context of the reply to the incoming call is default; alternatively, the content of the reply may be edited by the user via the external communication device 18.

The person skilled in the art should understand: the embodiments described above are only some preferred embodiments of the utility model, and should not be deemed as any limitation to the utility model. Though the utility model has been described in detail with reference to the above embodiments, the person skilled in the art can easily make amendments to the technical scheme described above in the embodiments or make equivalent replacement of some technical features. However, any modification, equivalent replacement or improvement made within the spirit and principle of the utility model shall be deemed as falling into the protected scope of the utility model.

1. An onboard calling device, comprising a processor, a speed measuring module, a weather module, a wireless connection module, and a calling module, wherein,
the speed measuring module is configured to obtain current vehicle speed information; the weather module is configured to obtain current weather information;
the processor is connected with the speed measuring module and the weather module respectively, and is configured to determine whether to accept or decline an incoming call or hang up a calling, and sends a short message, according to the vehicle speed information or the weather information;
the wireless connection module is connected with the processor and is configured to perform information transmission between the processor and an external communication device.

2. The onboard calling device according to claim 1, further comprising a storage module configured for storing the vehicle speed information, the weather information, and the short message.

3. The onboard calling device according to claim 1, wherein the wireless connection module is a Bluetooth module or a WiFi module.

4. The onboard calling device according to claim 1, wherein the speed measuring module is configured to obtain the current vehicle speed via an existing onboard system.

5. The onboard calling device according to claim 1, wherein the weather module is configured to obtain the current weather information from a server via an existing onboard system.
